(19) United States
(12) Patent Application Publication
(10) Pub. No.: US 2018/0185862 A1
(43) Pub. Date: Jul. 5, 2018

(54) Spray Gun

(71) Applicant: Zhejiang Prulde Electric Appliance Co., Ltd., Jinhua City (CN)

(72) Inventors: Weiming Yang, Jinhua City (CN); Ting Han, Jinhua City (CN)

(73) Assignee: Zhejiang Prulde Electric Appliance Co., Ltd., Jinhua City (CN)

(21) Appl. No.: 15/522,934

(22) PCT Filed: Jun. 6, 2016
(86) PCT No.: PCT/CN2016/000293

§ 371 Date: Apr. 28, 2017

(30) Foreign Application Priority Data
Apr. 19, 2016 (CN) 201620336034.2

(51) Int. Cl. B05B 7/24

(52) U.S. Cl. CPC B05B 7/241

(57) ABSTRACT

A spray gun comprises a gun body (1); a liquid container (4) with a top, the liquid container (4) having an opening on the top; a lid (3) for covering on the opening of the liquid container (4); a connecting pipe (2) connecting the gun body (1) to the lid (3); a tube (42) connected to the connecting pipe (2); wherein the lid (3) has a liquid feeding hole (41) communicating with the opening of the liquid container (4); the tube (42) enables flow of liquid between the liquid container (4) and the gun body (1). Compared with the prior art, by the improvement to the lid and the arrangement of the matched sealing device, the spray gun of the present invention can feed raw material into the liquid container without replacing the liquid container. In addition, during this process, pipes inside the spray gun can be ensured to be communicated with each other so as to prevent the fed material from splashing anywhere.

### RELATE APPLICATIONS

This application is a national phase entrance of and claims benefit to PCT Application for a spray gun, PCT/CN2016/000293, filed on Jun. 6, 2016, which claims benefit to Chinese Patent Application 201620336034.2, filed on Apr. 19, 2016. The specifications of both applications are incorporated here by this reference.

### TECHNICAL FIELD OF THE INVENTION

The present invention relates to an electric tool and in particular to a spray gun.

### BACKGROUND OF THE INVENTION

An electric spray gun is an apparatus which is powered by the quick release of liquid or compressed air and generally used for spraying and cleaning. In the prior art, there are spray guns of different structures according to different requirements. In the prior art, for the convenience of liquid feeding, a liquid container is generally arranged in a detachable structure. However, when in heavy workload, it is quite troublesome to detach the liquid container. In order to improve the liquid feeding efficiency, it is planned to provide a liquid feeding hole on the lid of the liquid container. However, considering the liquid feeding effect and sealing effect in the prior art, such an arrangement is usually infeasible.

### SUMMARY OF THE INVENTION

In view of the technical problems in the prior art, a technical problem to be solved by the present invention is to provide a spray gun by which the liquid feeding efficiency of a liquid container is improved while ensuring the spraying effect, and resources in the liquid container can be used more effectively by the gun body, thereby resulting in less waste.

To solve the technical problem, the spray gun comprises a gun body; a liquid container with a top, the liquid container having an opening on the top; a lid for covering on the opening of the liquid container; a connecting pipe connecting the gun body to the lid; a tube connected to the connecting pipe; wherein the lid has a liquid feeding hole communicating with the opening of the liquid container; the tube enables flow of liquid between the liquid container and the gun body.

Preferably, the liquid feeding hole further comprises a sealing device. This is to reduce the volatilization of liquid inside the liquid container and also to ensure the pressure inside the liquid container when the spray gun is used.

Preferably, the liquid feeding hole is defined by an annular extending wall protruding upwardly from the lid, the sealing device is a sealing cover for removably engaging the annular extending wall. Such a structure is simple in processing and good in sealing effect.

Preferably, the sealing device is a slider disposed on the lid. Such a structure saves space, but it is relatively high in both processing cost and requirements on processing precision.

Preferably, a one-way valve assembly is disposed inside the connecting pipe at a position corresponding to an air inlet of the gun body; the one-way valve assembly comprises a positioning base, a positioning sleeve fixed inside the connecting pipe and surrounding the positioning base, an one-way valve disposed inside the positioning base, and a flow-limiting sleeve disposed at a bottom of the positioning base; and a storage chamber defined inside the positioning base and below the one-way valve; wherein the flow-limiting sleeve has a small flow-limiting hole communicating the storage chamber, the storage chamber of the positioning base can store the liquid which flows backward through the small flow-limiting hole, so as to prevent the liquid from directly flowing to the one-way valve.

Such a structure is formed mainly for coordinating with the liquid container to prevent the liquid from flowing backward into the interior of the gun body.

Preferably, a spring is sleeved outside the one-way valve so that the one-way valve is better sealed.

Preferably, the liquid container has a concave bottom, and the tube rests toward a rim of the concave bottom of the liquid container. In this way, residual liquid after the usage is reduced, and the residual liquid is prevented from mixing with fresh liquid.

Preferably, a support column is further connected to the lid and to an outer side of the gun body, wherein the connecting pipe is connected to the support column so that the firm connection between the lid and the gun body is enhanced.

Compared with the prior art, by the improvement to the lid and the arrangement of the matched sealing device, the spray gun of the present invention can feed raw material into the liquid container without replacing the liquid container. In addition, during this process, pipes inside the spray gun can be ensured to be communicated with each other so as to prevent the fed material from splashing anywhere.

### BRIEF DESCRIPTION OF THE DRAWINGS

FIG. 1 is a sectional view of a spray gun according to an embodiment of the present invention of the spray gun;

FIG. 2 is another sectional view of the spray gun according to the embodiment of the present invention showing the one-way valve assembly;

FIG. 3 is a perspective view of the spray gun according to the embodiment of the present invention;

FIG. 4 is a perspective view of the one-way valve assembly according to the embodiment of the present invention; and

FIG. 5 is an exploded view of the one-way valve assembly according to the embodiment of the present invention.

### DETAILED DESCRIPTION OF THE INVENTION

To enable a further understanding of the present invention content of the invention herein, refer to the detailed description of the invention and the accompanying drawings below:

In the prior art, liquid is usually fed by opening a liquid container. However, such an operation is very inconvenient during continuous operations. Besides, in the prior art, it is hard to empty all the liquid from the bottom of the liquid container.

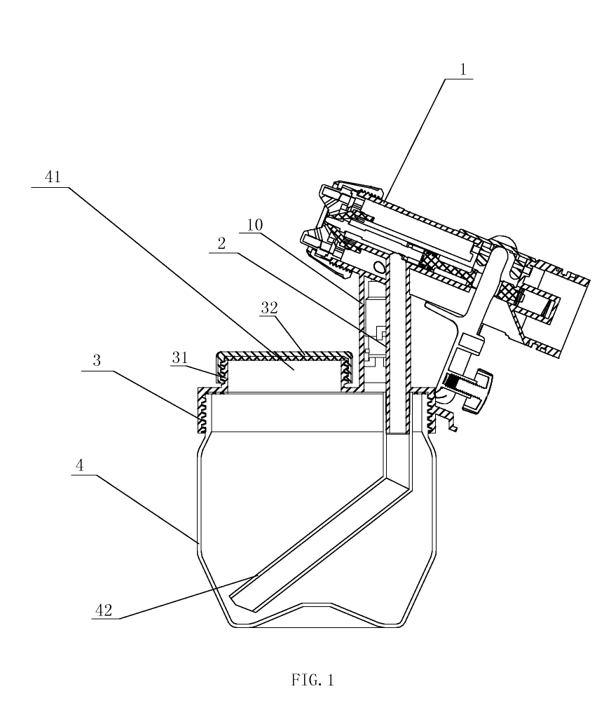

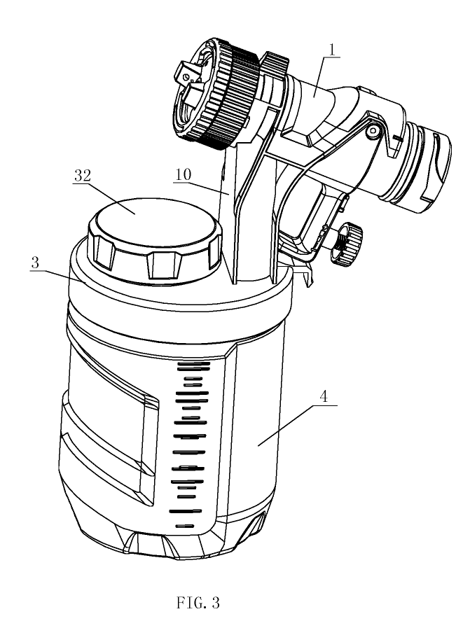

In order to solve such a problem, FIG. 1 to FIG. 5 show a spray gun according to an embodiment the present invention. The spray gun comprises a gun body 1, a hollow connecting pipe 2, a liquid container 4 disposed below the gun body 1, and a lid 3 for covering on the opening of the liquid container 4.

The connecting pipe 2 is arranged between the top of the lid 3 and the gun body 1, and a bottom end of the connecting pipe 2 is inserted below the lid 3; a tube 42 is inserted into the bottom of the connecting pipe 2; a tail end of the tube 42 is extended into the bottom of the liquid container 4; and the tube 42 enables flow of liquid between the liquid container 4 and the gun body 1 by the hollow connecting pipe 2.

In addition, a support column 10 is further connected to the lid 3 and to an outer side of the gun body 1, wherein the connecting pipe 2 is located inside the support column 10 and is connected to the support column 10 in parallel; the support column 10 is integrated with the lid 3 and the gun body 1, and the three are manufactured integrally.

The lid 3 is matched with the liquid container 4 and covered on an opening of the liquid container 4, and the lid 3 has a liquid feeding hole 41 communicating with the opening of the liquid container 4. Specifically, the liquid feeding hole 41 is defined by an annular extending wall 31 protruding upwardly from the lid 3, and a sealing device is disposed on the liquid feeding hole 41. According to actual requirements, a sealing cover 32 in threaded connection with the extending wall 31 can be selected as the sealing device; the sealing cover 32 is removably engaging the annular extending wall 31. Such a structure is simple and convenient in manufacturing, and when in use, liquid can be fed just by unscrewing the sealing cover.

Or alternatively, the sealing device is a slider provided disposed on the lid 3. The slider is more invisible and also convenient to use.

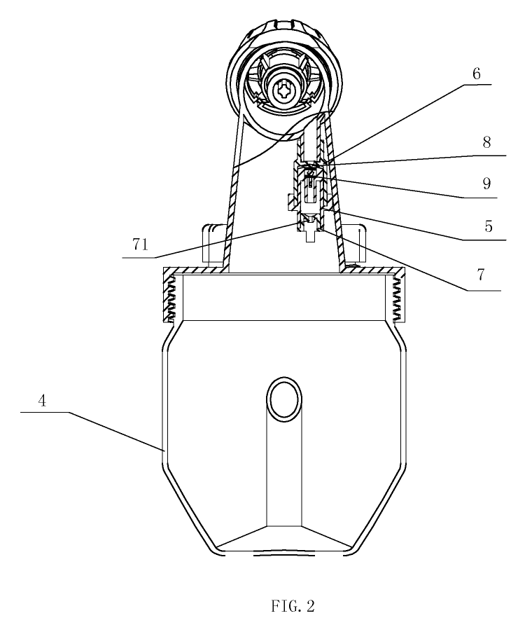

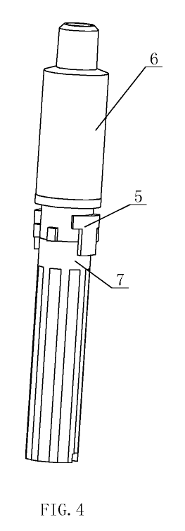

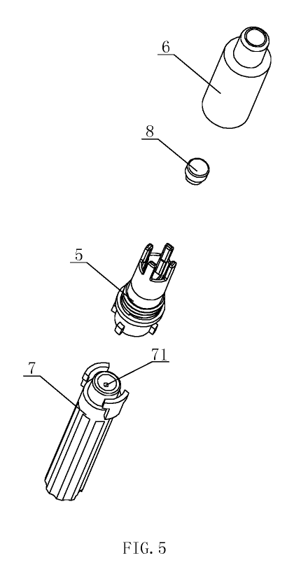

As shown in FIG. 2, FIG. 4 and FIG. 5, a one-way valve assembly is disposed inside the connecting pipe 2 at a position corresponding to an air inlet of the spray gun. the one-way valve assembly comprises a positioning base 5, a positioning sleeve 6 fixed inside the connecting pipe 2 and surrounding the positioning base 5, an one-way valve 8 disposed inside the positioning sleeve 6, and a flow-limiting sleeve 7 disposed at a bottom of the positioning base 5; and a storage chamber defined inside the positioning base 5 and below the one-way valve 8; wherein the bottom of the positioning base 5 is extended from the bottom of the position-limiting sleeve 6; the flow-limiting sleeve 7 has a small flow-limiting hole 71 communicating the storage chamber, the storage chamber of the positioning base 5 can store the liquid which flows backward through the small flow-limiting hole 71, so as to prevent the liquid from directly flowing to the one-way valve 8. A spring 9 is sleeved outside the one-way valve 8 so that the one-way valve 8 is better sealed. Such an arrangement ensures that liquid inside the pot body will not flow backward into the gun body.

The liquid container 4 has a concave bottom, and the tube 42 rests toward a rim of the concave bottom of the liquid container 4. In this way, residual liquid after the usage is reduced, and the residual liquid is prevented from mixing with fresh liquid.

In conclusion, compared with the prior art, the present invention improves the liquid feeding efficiency of the liquid container 4 while ensuring the spraying effect. As long as a sealing device is provided on the liquid feeding hole 41, liquid can be fed without detaching the liquid container 4. In this way, resources in the liquid container can be used more effectively by the gun body, thereby resulting in less waste.

1. A spray gun comprising:
a gun body;
a liquid container with a top, the liquid container having an opening on the top;
a lid for covering on the opening of the liquid container;
a connecting pipe connecting the gun body to the lid;
a tube connected to the connecting pipe;
wherein
the lid has a liquid feeding hole communicating with the opening of the liquid container;
the tube enables flow of liquid between the liquid container and the gun body.

2. The spray gun of claim 1, further comprising a sealing device for sealing the liquid feeding hole.

3. The spray gun of claim 2, wherein the liquid feeding hole is defined by an annular extending wall protruding upwardly from the lid, the sealing device is a sealing cover for removably engaging the annular extending wall.

4. The spray gun of claim 2, wherein the sealing device is a slider disposed on the lid.

5. The spray gun of claim 1, further comprising
a one-way valve assembly is disposed inside the connecting pipe at a position corresponding to an air inlet of the gun body; the one-way valve assembly comprises a positioning base, a positioning sleeve fixed inside the connecting pipe and surrounding the positioning base, an one-way valve disposed inside the positioning base, and a flow-limiting sleeve disposed at a bottom of the positioning base; and
a storage chamber defined inside the positioning base and below the one-way valve;
wherein the flow-limiting sleeve has a small flow-limiting hole communicating the storage chamber, the storage chamber of the positioning base can store the liquid which flows backward through the small flow-limiting hole, so as to prevent the liquid from directly flowing to the one-way valve.

6. The spray gun of claim 5, further comprising a spring sleeved outside the one-way valve.

7. The spray gun of claim 1, wherein the liquid container has a concave bottom, and the tube rests toward a rim of the concave bottom of the liquid container.

8. The spray gun of claim 1, further comprising a support column connected to the lid and to an outer side of the gun body, wherein the connecting pipe is connected to the support column.
